(19) United States
(12) Patent Application Publication
(10) Pub. No.: US 2006/0004933 A1
(43) Pub. Date: Jan. 5, 2006

(54) Network interface controller signaling of connection event

(76) Inventors: Sujoy Sen, Portland, OR (US); Anil Vasudevan, Portland, OR (US); Linden Cornett, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/883,362

(22) Filed: Jun. 30, 2004

(51) Int. Cl. G06F 13/24

(52) U.S. Cl. 710/48

(57) ABSTRACT

In general, in one aspect, the disclosure describes a method that includes determining, at a first processor in a multi-processor system, that a network connection event is associated with a connection mapped to a second processor in the multi-processor system. In response, a network interface controller of the system is caused to signal an interrupt to the second processor.

### REFERENCE TO RELATED APPLICATIONS

This relates to U.S. patent application Ser. No. 10/815,895, entitled “ACCELERATED TCP (TRANSPORT CONTROL PROTOCOL) STACK PROCESSING”, filed on Mar. 31, 2004; this also relates to an application filed the same day as the present application entitled “DISTRIBUTING TIMERS ACROSS PROCESSORS” naming Sujoy Sen, Linden Cornett, Prafulla Deuskar, and David Mintum as inventors and having attorney/docket number 42390.P19610.

### BACKGROUND

Networks enable computers and other devices to communicate. For example, networks can carry data representing video, audio, e-mail, and so forth. Typically, data sent across a network is divided into smaller messages known as packets. By analogy, a packet is much like an envelope you drop in a mailbox. A packet typically includes “payload” and a “header”. The packet's “payload” is analogous to the letter inside the envelope. The packet's “header” is much like the information written on the envelope itself. The header can include information to help network devices handle the packet appropriately.

A number of network protocols cooperate to handle the complexity of network communication. For example, a transport protocol known as Transmission Control Protocol (TCP) provides “connection” services that enable remote applications to communicate. TCP provides applications with simple commands for establishing a connection and transferring data across a network. Behind the scenes, TCP transparently handles a variety of communication issues such as data retransmission, adapting to network traffic congestion, and so forth.

To provide these services, TCP operates on packets known as segments. Generally, a TCP segment travels across a network within (“encapsulated” by) a larger packet such as an Internet Protocol (IP) datagram. Frequently, an IP datagram is further encapsulated by an even larger packet such as an Ethernet frame. The payload of a TCP segment carries a portion of a stream of data sent across a network by an application. A receiver can restore the original stream of data by reassembling the received segments. To permit reassembly and acknowledgment (ACK) of received data back to the sender, TCP associates a sequence number with each payload byte.

Many computer systems and other devices feature host processors (e.g., general purpose Central Processing Units (CPUs)) that handle a wide variety of computing tasks. Often these tasks include handling network traffic such as TCP/IP connections. The increases in network traffic and connection speeds have placed growing demands on host processor resources. To at least partially alleviate this burden, some have developed TCP Off-load Engines (TOEs) dedicated to off-loading TCP protocol operations from the host processor(s).

### BRIEF DESCRIPTION OF THE DRAWINGS

FIGS. 1A-1E are diagrams that illustrate use of a network interface controller interrupt to provide cross-processor signaling of a connection event.

FIGS. 2 and 3 are flow-charts of processes that use a network interface controller interrupt to provide cross-processor signaling of a connection event.

### DETAILED DESCRIPTION

As described above, network connections and traffic have increased greatly in recent years. Processor speeds have also increased, partially absorbing the increased burden of packet processing operations. Unfortunately, the speed of memory has generally failed to keep pace. Each memory operation performed during packet processing represents a potential delay as a processor waits for the memory operation to complete. For example, in Transmission Control Protocol (TCP), the state of each connection is stored in a block of data known as a TCP control block (TCB). Many TCP operations require access to a connection's TCB. Frequent memory accesses to retrieve TCBs can substantially degrade system performance.

To speed memory operations, many processors include caches that provide faster access to data than memory. Often, the cache and memory form a hierarchy where the cache is searched for requested data. In some caching schemes, if the cache does not store requested data (a cache “miss”), the data is loaded into the cache from memory for future use. To the extent that a connection's TCB remains cached, operations for a connection can avoid the delay associated with memory transactions.

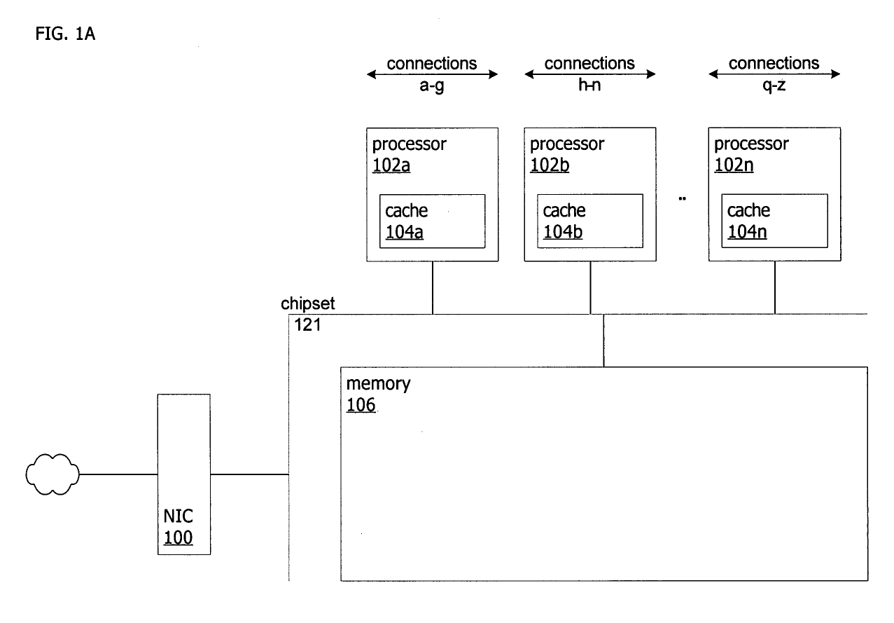

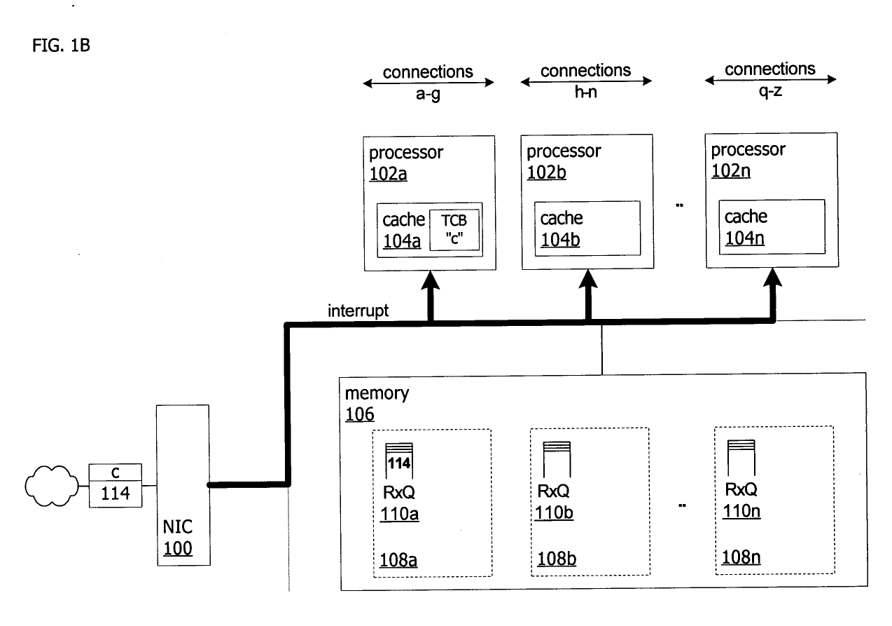

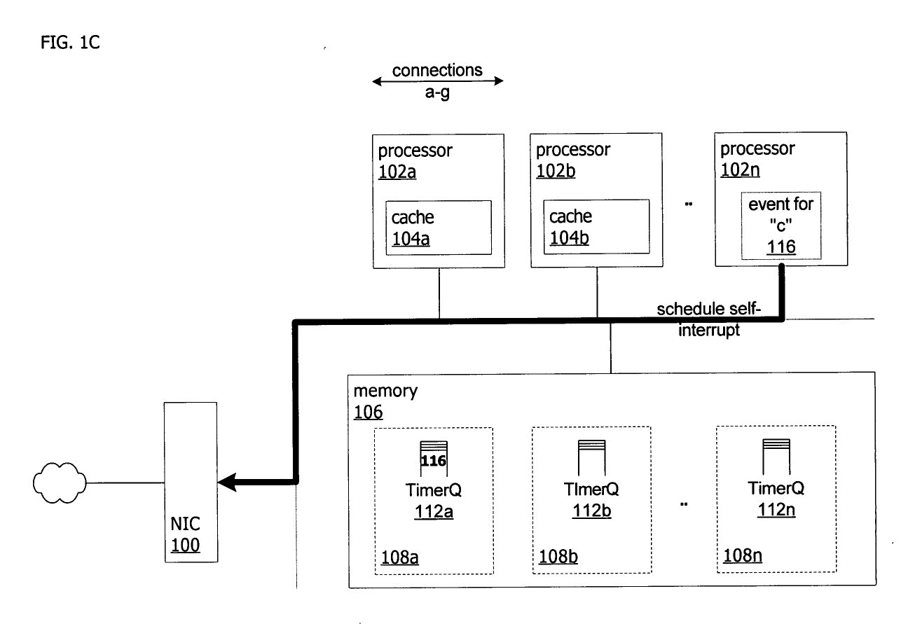

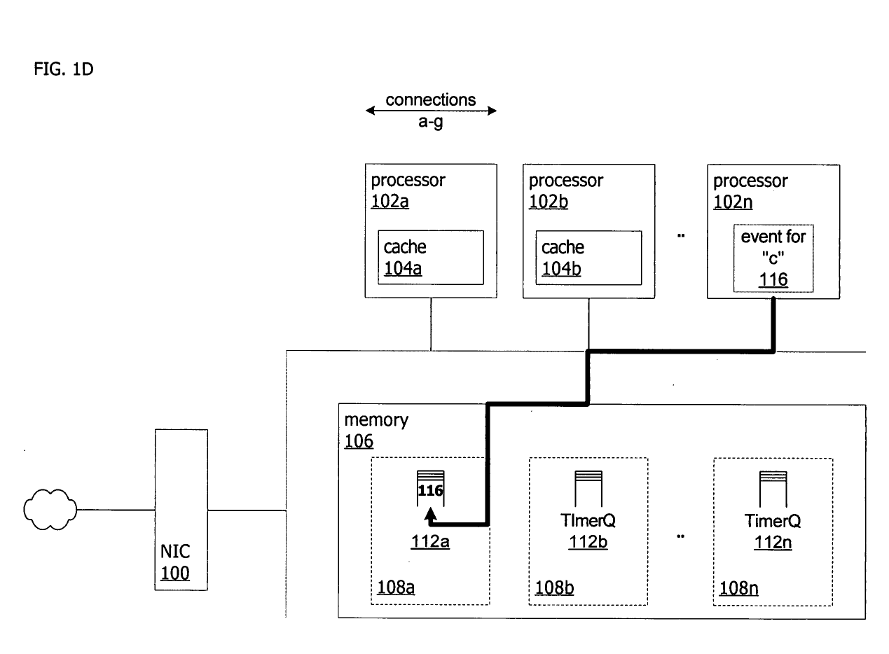

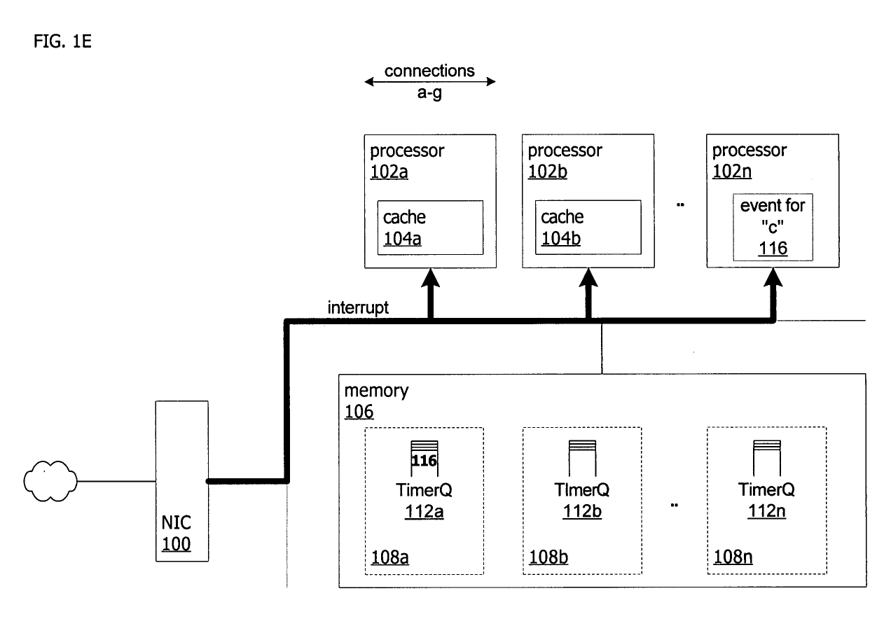

To increase the likelihood that a connection's TCB (and other connection related information) will remain cached, FIG. 1A depicts a multi-processor 102a-102n system that maps different connections to different processors 102a-102n. As shown, the system includes multiple processors 102a-102n, memory 106, and one or more network interface controllers 100 (NICs). The NIC 100 includes circuitry that transforms the physical signals of a transmission medium into a packet, and vice versa. The NIC 100 circuitry also performs de-encapsulation, for example, to extract a TCP/IP packet from within an Ethernet frame.

The processors 102a-102b, memory 106, and network interface controller(s) are interconnected by a chipset 121 (shown as a line). The chipset 121 can include a variety of components such as a controller hub that couples the processors to I/O devices such as memory 106 and the network interface controller(s) 100.

The sample scheme shown does not include a TCP off-load engine. Instead, the system distributes different TCP operations to different components. While the NIC 100 and chipset 201 may perform some TCP operations (e.g., the NIC 100 may compute a segment checksum), most are handled by processor's 102a-102n.

As shown, different connections may be mapped to different processors 102a-102n. For example, operations on packets belonging to connections (arbitrarily labeled) “a” to “g” may be handled by processor 102a, while operations on packets belonging to connections “h” to “n” are handled by processor 102b. This mapping may be explicit (e.g., a table) or implicit.

To illustrate operation of the system, FIG. 1B shows a packet 114 received by the network interface controller 100. The network interface controller 100 can determine which processor 102a-102n is mapped to the packet's 114 connection, for example, by hashing packet data (the packet's “tuple”) identifying the connection (e.g., a TCP/IP packet's Internet Protocol source and destination address and a TCP source and destination port). In the example shown, a hash of the packet's 114 tuple indicates that the packet belongs to a connection, “c”, mapped to processor 102a.

As shown, each processor 102a-102n has a corresponding receive queue 110a-110n (RxQ) that identifies received packets to be handled by the respective processor. While the queues 110a-110n may store the actual packet data, the queues 110a-110n, generally, will instead store a packet descriptor that identifies where the packet is stored in memory 106. A descriptor may also include other information (e.g., the hash results, identification of the mapped processor, and so forth). For example, as shown, the network interface controller 100 enqueued a descriptor for received packet 114 (e.g., using Direct Memory Access (DMA)) in the queue 110a corresponding to processor 102a. The processors 102a-102n consume entries from their respective queues 110a-110n and perform operations for the corresponding packet(s) such as navigating the TCP state machine for a connection, performing segment reordering and reassembly, tracking acknowledged bytes in a connection, managing connection windows, and so for (see, for example, The Internet's Engineering Task Force (IETF), Request For Comments #793).

As shown, to alert the processor 102a of the arrival of a packet, the network interface controller 100 can signal an interrupt. Potentially, the controller 100 may use interrupt moderation which delays an interrupt for some period of time. This increases the likelihood multiple packets will have arrived before the interrupt is signaled, enabling a processor to work on a batch of packets and reducing the overall number of interrupts generated.

In response to the interrupt, the processor 102a may dequeue and process the next entry (or entries) in its receive queue 110a. Since the processor 102a only processes packets for a limited subset of connections, the likelihood that the TCB for connection “c” remains in the processor's 102a cache 104a increases.

FIG. B illustrated delivery of a received packet to the processor 102a-102n mapped to the packet's connection. However, some connection-related events may originate or be received by the “wrong” processor (i.e., a processor other than the processor mapped to the connection). For example, though processor 102a is mapped to process packets in connection “c”, an application on processor 102n may initiate a transmit operation over connection “c”. Handling the event by the “wrong” processor, processor 102n in this case, can largely negate many of the advantages of the scheme shown in FIG. 1B. For example, reading a connection's TCB into the “wrong” cache 104n may victimize a TCB of a connection mapped to the processor 102n from the cache 104n. Additionally, loading a connection's TCB into the “wrong” cache 104n may both necessitate invalidation of the “right” cache's TCB entry 104a and may require a locking scheme to maintain data consistency across different processors accessing the same TCB.

FIGS. 1C-1E illustrate a scheme that transfers handling of events to the “right” processor 102a-102n. To notify the “right” processor, the “wrong” processor schedules an interrupt on the network interface controller 100. The “wrong” processor 102n also writes data that enables processors 102a-102n receiving the interrupt to identify its cause. For example, processor 102n can set a software interrupt flag in an interrupt cause register maintained by the network interface controller 100. In response to the interrupt request, the network interface controller 100 interrupts the processors 102a-102n mapped connections. The network interface controller drivers operating on the processors 102a-102n respond to the interrupt by checking the data (e.g., flag(s)) indicating the interrupt cause. For example, the interrupt cause may indicate either a hardware interrupt (e.g., in response to one or more received packets) and/or a software generated interrupt (e.g., a transfer of event handling across processors). Based on the identified interrupt cause, the “right” processor can process the received packets and/or inter-processor event transfer.

To illustrate, as shown in FIG. 1C, processor 102n determines that an event 116 associated with connection “c” (e.g., a transmit operation, a connection timer, or connection start, reset, or termination) should be handled by processor 102a. Such a determination may be made by accessing a table associating connections with processors and/or hashing the TCP/IP tuple associated with the packet's connection. As shown, processor 102n schedules an interrupt by network interface controller 100.

As shown in FIG. 1D, in addition to scheduling the network interface controller 100 interrupt, processor 102n can also enqueue an entry for the event 116 in a processor-specific queue 112a and/or a connection-specific queue (not shown). The entry includes or references data (e.g., the connection, type of event, and so forth) used by the “right” processor 102 to respond to the event 116.

As shown in FIG. 1E, the network interface controller 100 then generates the scheduled interrupt for each processor 102a-102n having a receive queue 110a-110n. Alternately, the controller 100 can issue an interrupt targeted to a specific processor. After receiving an interrupt and determining that the interrupt signifies an event registered by a “wrong” processor 102n (e.g., by examining the interrupt cause register), the “right” processor 102a can retrieve the entry from the queue 112a and respond accordingly.

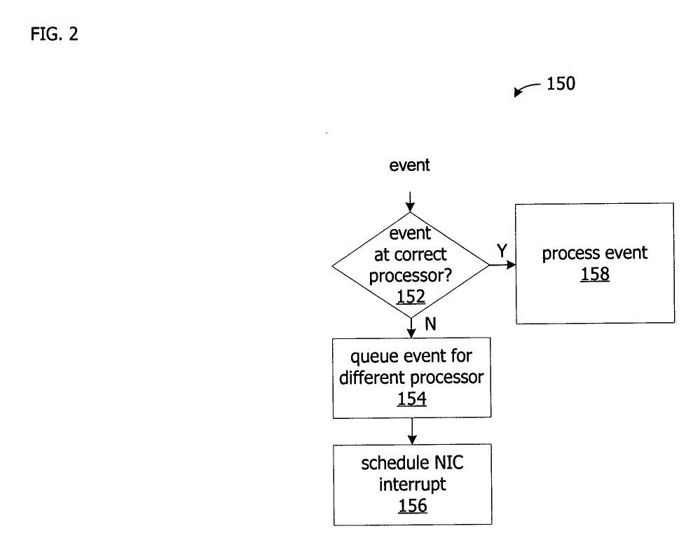

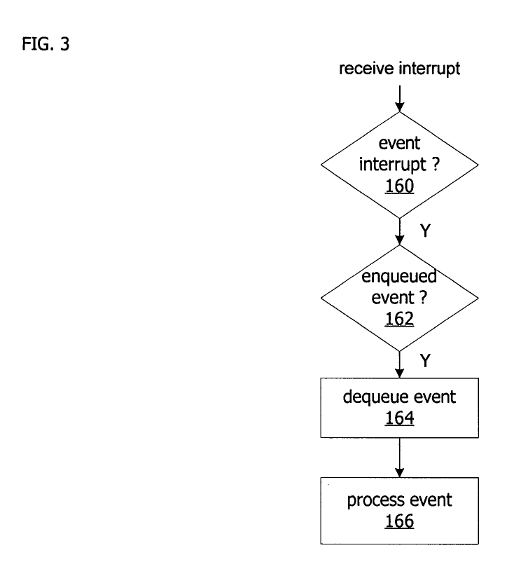

FIG. 2 and FIG. 3 illustrate processes implemented by the processors 102a-102n. In FIG. 2, a processor 102n determines 152 if the connection associated with an event is mapped to a different processor 102a. If so, the processor 102n can enqueue 154 an event entry and schedule 156 an interrupt to signal the event. As shown in FIG. 3, in response to the interrupt, the processor can determine 160 whether the interrupt was a response to an event initially handled by a different processor (e.g., by checking the interrupt cause register or other data associated with NIC 100). The processor can then dequeue 164 the events, if any 162, and perform the appropriate operations 166. This dequeueing 164 may be performed by accessing from a processor-specific queue (e.g., 112) and/or by accessing different connection-specific queues of connections mapped to the processor.

The scheme illustrated above can, potentially, increase the likelihood that connection specific data (e.g., the TCB) is cached in the same processor for the duration of a connection. The scheme also can eliminate or reduce the need for locks on connection-specific data. Additionally, by “piggybacking” on the network interface controller interrupt system, the scheme need not increase system complexity with an additional signaling system or burden the system with additional interrupts.

Though the description above repeatedly referred to TCP as an example of a protocol that can use techniques described above, these techniques may be used with many other protocols such as protocols at different layers within the TCP/IP protocol stack and/or protocols in different protocol stacks (e.g., Asynchronous Transfer Mode (ATM)). Further, within a TCP/IP stack, the IP version can include IPv4 and/or IPv6.

While FIGS. 1A-1E and FIG. 4 depicted a typical multi-processor host system, a wide variety of other multi-processor architectures may be used. For example, while the systems illustrated did not feature TOEs, an implementation may nevertheless feature them.

The techniques above may be implemented using a wide variety of circuitry. The term circuitry as used herein includes hardwired circuitry, digital circuitry, analog circuitry, programmable circuitry, and so forth. The programmable circuitry may operate on computer programs disposed on a computer readable medium.

Other embodiments are within the scope of the following claims.

What is claimed is:

1. A method, comprising:
determining, at a first processor in a multi-processor system, that a network connection event is associated with a connection mapped to a second processor in the multi-processor system; and
in response, causing a network interface controller of the system to signal an interrupt to the second processor.

2. The method of claim 1, wherein the network connection comprises a Transmission Control Protocol (TCP) connection.

3. The method of claim 1, wherein the event comprises at least one selected from the group of: a transmit operation and connection teardown.

4. The method of claim 1, further comprising setting data of the network interface controller to identify the interrupt cause.

5. The method of claim 4, wherein the setting data comprises setting a bit identifying software interrupt generation.

6. The method of claim 1, wherein the determining the event is associated with a connection mapped to the second processor comprises determining based on a data included within a Transmission Control Protocol/Internet Protocol (TCP/IP) packet, the data including, at least, an Internet Protocol source and destination address and a TCP source and destination port.

7. The method of claim 1, wherein causing the network interface controller to signal an interrupt comprises causing the network interface controller to signal an interrupt to multiple processors in the multi-processor system including the second processor.

8. The method of claim 1, further comprising queuing an entry for the event in at least one selected from the following group: a processor specific queue and a connection specific queue.

9. The method of claim 8, further comprising:
receiving the interrupt at the different processor; and
dequeuing an entry for the event at the second processor.

10. An apparatus, comprising:
a chipset;
at least one network interface controller coupled to the chipset;
multiple processors coupled to the chipset; and
instructions, disposed on a computer readable medium, to cause one or more of the multiple processors to perform operations comprising:
determining that an event associated with a Transmission Control Protocol (TCP) connection is mapped to a second one of the processors; and
in response, causing the at least one network interface controller signal an interrupt to the second processor.

11. The apparatus of claim 10, wherein the instructions further comprise instructions to set a bit in an interrupt cause register of the network interface controller.

12. The apparatus of claim 10, wherein the determining the event is associated with a connection mapped to the second processor comprises determining based on data included within a Transmission Control Protocol/Internet Protocol (TCP/IP) packet, the data including, at least, an Internet Protocol source and destination address and a TCP source and destination port.

13. The apparatus of claim 1, further comprising instructions to queue an entry for the event in at least one selected from the following group: a processor specific queue and a connection specific queue.

14. The apparatus of claim 10, further comprising instructions to:
receive an interrupt; and
dequeue an entry for an event.

15. A computer program, disposed on a computer readable medium, the program including instructions for causing a processor to:
determine that a network connection event is associated with a connection mapped to a second processor in a multi-processor system; and
in response, cause a network interface controller of the system to signal an interrupt to the second processor.

16. The program of claim 15, wherein the network connection comprises a Transmission Control Protocol (TCP) connection.

17. The program of claim 15, wherein the event comprises at least one selected from the group of: a transmit operation and a connection teardown.

18. The program of claim 15, wherein the instructions further comprise instructions to set a bit in an interrupt register of the network interface controller.

19. The program of claim 15, wherein the instructions to determine the event is associated with a connection mapped to a different processor comprise instructions to determine based on data included within a Transmission Control Protocol/Internet Protocol (TCP/IP) packet, the data including, at least, an Internet Protocol source and destination address and a TCP source and destination port.

20. The program of claim 15, further comprising instructions to cause the processor to queue an entry for the event in at least one selected from the following group: a processor specific queue and a connection specific queue.
